(19) United States
(12) Patent Application Publication
(10) Pub. No.: US 2018/0222229 A1
(43) Pub. Date: Aug. 9, 2018

(54) LUBRICANT FROM A RESERVOIR

(71) Applicant: HEWLETT-PACKARD DEVELOPMENT COMPANY, L.P., Houston, TX (US)

(72) Inventors: Erikk Arvo Ojala, Vancouver, WA (US); Mark Christopher Riehl, Vancouver, WA (US)

(73) Assignee: HEWLETT-PACKARD DEVELOPMENT COMPANY, L.P., Houston, TX (US)

(21) Appl. No.: 15/748,167

(22) PCT Filed: Oct. 13, 2015
(86) PCT No.: PCT/US2015/055270

§ 371 Date: Jan. 26, 2018

(51) Int. Cl. B41J 29/00; B05C 11/105

(52) U.S. Cl. CPC B41J 29/00; B05C 11/105

(57) ABSTRACT

A lubricating system includes a port to provide access to a reservoir in a carriage base to allow lubricant to be injected into the reservoir and a number of channels molded into the carriage base to extract the lubricant from the reservoir and deliver the lubricant to locations where carriage bearings of the carriage base are in contact with a carriage rod of a printer to reduce friction.

### BACKGROUND

Printers provide a user with a hardcopy of a document by printing a representation of the document from digital data onto a print medium. The printer, such as a dimensional (2D) printer, includes a number of components such as a carriage base with printheads used to eject printing fluid or other printable material onto the print medium to form an image. The carriage base may move along a carriage rod via a motor to eject the printing fluid onto the print medium to form the image. Further, the printer may be a 3 dimensional (3D) printer. The 3D printer uses printheads to print on a bed of build material to create a 3D object.

### BRIEF DESCRIPTION OF THE DRAWINGS

The accompanying drawings illustrate various examples of the principles described herein and are a part of the specification. The examples do not limit the scope of the claims.

FIG. 1 is a diagram of a system for lubricating locations in a printer to reduce friction, according to one example of principles described herein.

FIG. 2 is a diagram of a carriage base, according to one example of principles described herein.

FIG. 3 is a diagram of a lubricating system of a carriage base, according to one example of principles described herein

FIG. 4 is a diagram of a carriage base slidably mounted on a carriage rod, according to one example of principles described herein.

FIG. 5 is a diagram of a port and a number of channels molded into a carriage base, according to one example of principles described herein.

FIG. 6 is a flowchart of a method for lubricating locations in a printer to reduce friction, according to one example of principles described herein.

FIG. 7 is a flowchart of a method for lubricating locations in a printer to reduce friction, according to one example of principles described herein.

Throughout the drawings, identical reference numbers designate similar, but not necessarily identical, elements.

### DETAILED DESCRIPTION

As mentioned above, printers provide a user with a physical copy of a document by printing a hardcopy of the document onto a print medium. The printer includes a number of components such as a carriage base with printheads used to eject printing fluid or other printable material onto the print medium to form an image. The carriage base may be driven to move along the print medium by a motor while being guided by a carriage rod. Often, the carriage base includes a number of carriage bearings. The carriage bearings make contact with the carriage rod.

During the printing process, the carriage rod frequently becomes contaminated with debris. The debris may include print medium particles, aerosol, printing fluid, dust, other debris, and mixtures of these. As the debris continues to contaminate the carriage rod, friction begins to build up on locations where the carriage bearings contact the carriage rod. This leads to increased friction as the carriage base moves along the carriage rod. The increased friction puts strain on the printer components. This strain causes the components of the printer to heat up, wear prematurity, and may eventually result in component failure.

The principles described herein include a system for lubricating the carriage bearings to improve performance and increase component lifespan. Such a system includes a port to provide access to a reservoir in a carriage base to allow lubricant to be injected into the reservoir and a number of channels molded into the carriage base to extract lubricant from the reservoir and deliver lubricant to locations where carriage bearings of the carriage base are in contact with a carriage rod of a printer. As a result, the friction at these locations may be reduced to improve the life of the components of the printer.

In the present specification and in the appended claims, the term “port” means an input or connection point. Specifically, in the context of the claims, the “port” refers to an input on a carriage base that is used to access a reservoir such that lubricant can be injected into and ultimately fill a reservoir. The port may allow for an inspection to be conducted verifying that the reservoir, interior to the carriage base, is filled with the lubricant.

In the present specification and in the appended claims, the term “reservoir” means a repository for some material. In the context of the claims, the “reservoir” refers to a repository inside of a carriage base that is used to retain lubricant. The reservoir may be filled with lubricant at a time of manufacture of a printer via a port and through the port as desired thereafter.

In the present specification and in the appended claims, the term “channel” means a passage in a carriage base from the reservoir to an opening located near a point of contact between the carriage bearings and the carriage rod. The channels may be a particular shape. The shape of the channels may determine a pressure differential that is created between an interior and exterior of the channels to extract and deliver lubricant to a number of locations.

In the present specification and in the appended claims, the term “pressure differential” means a difference in pressure between two points. In the context of the claims, “pressure differential” refers to a difference in pressure between two points associated with a number of channels molded into a carriage base of a printer. The pressure differential may be determined between a point immediately inside of one of the channels and a point immediately outside the channels. The larger the pressure differential the larger the amount of lubricant that is extracted from a channel.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. However, the present apparatus, systems, and methods may be practiced without these specific details. Reference in the specification to “an example” or similar language means that a particular feature, structure, or characteristic described in connection with that example is included as described, but may not be included in other examples.

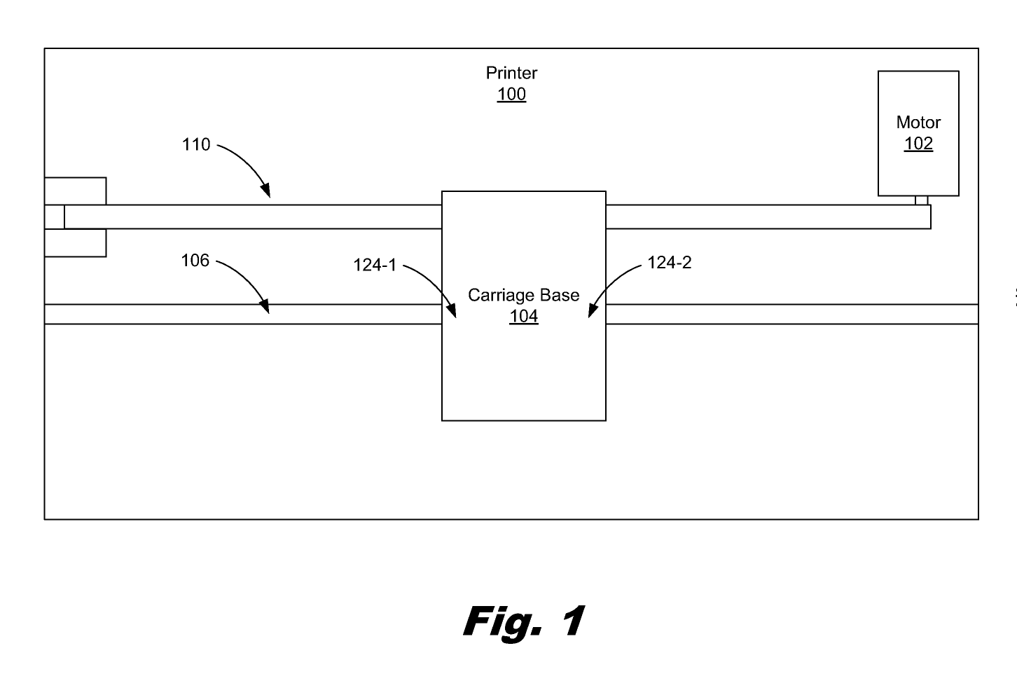

Referring now to the figures, FIG. 1 is a diagram of a system for lubricating locations in a printer to reduce friction, according to one example of principles described herein. As described below, a printer includes a number of components. As these components physically interact with each other during a print job, friction may be created, particularly between the carriage bearings and a carriage rod, as described above. To reduce this friction, lubricant may be delivered to locations where these components physically interact.

As illustrated, the diagram includes a printer (100). The printer may be a 2 dimensional (2D) printer or a 3 dimensional (3D) printer. The printer (100) provides a user with a physical copy of a document by printing a hardcopy from a digital representation of the document using printing fluid or other marking fluid and a print medium. The printer (100) includes a number of components such as a carriage base (104) with printheads used to eject printing fluid or other printable material onto the print medium to form an image. The carriage base (104) may move along a carriage rod (106) via a motor (102) to eject the printing fluid onto the print medium to form the image.

In some examples, the carriage base (104) is slidably mounted on the carriage rod (106) via a number of carriage bearings (124) to allow the carriage base (104) to move along the carriage rod (106). In an example, the carriage rod (106) spans the length of the printer (100). This allows the carriage base (104) move from one side of the printer (100) to the other side of the printer (100) as driven by the motor (102). As a result, the carriage rod (106) may be used for supporting the carriage base (104) during the movement of the carriage base (104).

As illustrated, the printer (100) includes the motor (102). The motor (102) moves the carriage base (104) along the carriage rod (106) with a printer belt (110). As the motor (102) turns, the motor (102) engages the printer belt (110), which transfers the drive from the motor (102) to the carriage base (104). This causes a lateral movement of the carriage base (104) along the carriage rod (106). As a result, the motor (102) may move the carriage base (104) back-and-forth along the carriage rod (106).

The motor (102) moves the carriage base (104) along the carriage rod (106) based on the digital data of the print job. For example, if the print job demands an image is to be formed on the entire print medium, the motor (102) moves the carriage base (104) back-and-forth along the entire carriage rod (106) to selectively eject printing fluid or other printable material onto the print medium to form the image. For another example, if the print job demands an image is to be formed on the right side of the print medium, the motor (102) moves the carriage base (104) along the right side of the carriage rod (106) to eject printing fluid or other printable material onto the print medium to form the image.

As noted above, the carriage base (104) includes a lubricating system (114). As described below, the lubricating system (114) includes a number of channels. The channels may be molded into the carriage base (104) to extract lubricant from a reservoir of the carriage base (104). The lubricant may be a substance that reduces friction at locations where carriage bearings (124) of the carriage base (104) are in contact with the carriage rod (106) of the printer (100). In an example, the amount of lubricant that is extracted from the reservoir is based on a pressure differential. Further, the lubricant is delivered to locations where the carriage bearings (124) of the carriage base (104) are in contact with the carriage rod (106) of the printer (100). As a result, the lubricant may reduce friction between the carriage bearings (124) and the carriage rod (106). This improves the life of the components of the printer (100). More information about the channels, the pressure differential, and the reservoir is described below.

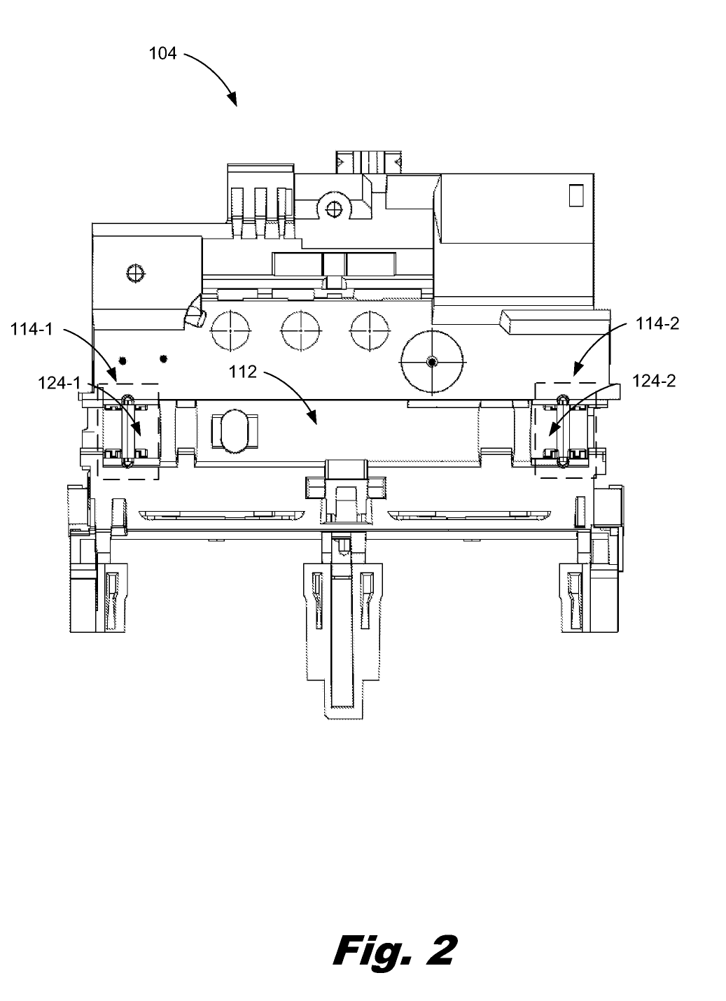

FIG. 2 is a diagram of a carriage base, according to one example of principles described herein. As described below, a carriage base includes a number of features. The features may include a slot and a number of lubricating systems.

As illustrated, the carriage base (104) includes a slot (112). The slot (112) may be sized to accommodate a carriage rod (106). In some examples, the size of the slot is dependent on the size of the carriage rod (106). For example, larger sized printers use a larger sized carriage rod. Similarly, smaller printers use a smaller sized carriage rod. As a result, the size of the slot (112) may be printer specific.

Although not expressly illustrated, the carriage base (104) may include a number of carriage bearings (124). The carriage base (104) may include a first carriage bearing (124-1) and a second carriage bearing (124-2). The first carriage bearing (124-1) may be located on the left side of the carriage base (104). The second carriage bearing (124-2) may be located on the right side of the carriage base (104). The carriage bearings (124) may be located in an opening of the slot (112) and slightly protrude from the opening in the slot (112). This allows the carriage bearings (124) to make contact with the carriage rod (106). In some examples, the carriage bearings (124) may be round to allow the carriage bearings (124) to smoothly roll along the carriage rod (106). As a result, the carriage base (104) may be slidably mounted on the carriage rod (106) via a number of carriage bearings (124) to allow the carriage base (104) to move back-and-forth along the carriage rod (106).

The carriage base (104) includes a lubricating system (114). The lubricating system (114) includes a first lubricating system (114-1) and a second lubricating system (114-2). The lubricating system (114) may deliver lubricant to locations where the carriage bearings (124) make contact with the carriage rod (106) to reduce friction at these locations.

In an example, the first lubricating system (114-1) may be located on the left side of the carriage base (104). As a result, lubricant may be delivered to locations on the far left side of the printer. The second lubricating system (114-2) may be located on the right side of the carriage base (104). As a result, lubricant may be delivered to locations on the far right side of the printer. Due to the placement of the lubricating system (114) on the carriage base (104), lubricant may be delivered to every location where the carriage bearings (124) make contact with the carriage rod (106).

The lubricating system (114) includes a number of channels, a number of reservoirs, and a number of ports. As mentioned above, the number of channels are molded into the carriage base (104) to extract, based on a pressure differential, lubricant from a reservoir of the carriage base (104) and deliver lubricant to locations where the bearings of the carriage base (104) are in contact with the carriage rod (106) of the printer (100) to reduce friction between the bearings and the carriage rod (106). By lubricating the carriage bearings (124) via the lubricating system (114), the performance of the components of the printer (100) increases and as well as the life span of the component.

While this example has been described with reference to the carriage base including a two carriage bearings and located in specific location of the carriage base, the carriage base may include any appropriate number of carriage bearings located in the same locations as illustrated or different locations on the carriage base. For example, the carriage base may include four carriage bearings.

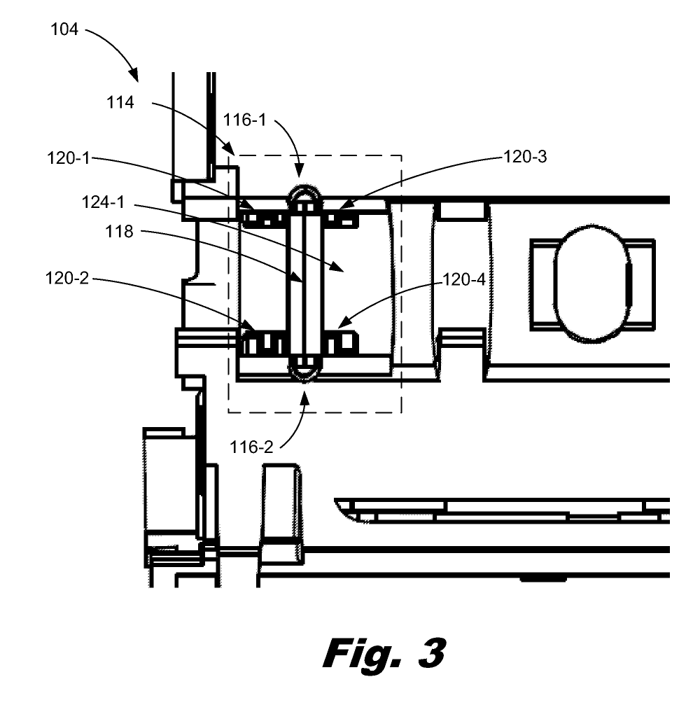

FIG. 3 is a diagram of a lubricating system of a carriage base, according to one example of principles described herein. As described below, the carriage base includes a lubricating system. The lubricating system includes a number of channels, a reservoir, and a number of ports.

As illustrated, the lubricating system (114) includes a number of ports (120). For example, the lubricating system (114) includes a first port (116-1) and a second port (116-2). The each of the ports (116) may be an input or connection point. Specifically, each of the ports (116) may be an input on a carriage base (104) that is used to access a reservoir (118) such that lubricant can be injected into and ultimately fill the reservoir (118). The first port (116-1) may be located at one end of the reservoir (118). The second port (116-2) may be located at an opposite end of the reservoir (118). In one example, each of the ports (116) provides access to the reservoir (118) in the carriage base (104). This allows the lubricant to be injected into both the first port (116-1) and the second port (116-2) to fill the reservoir (118) with the lubricant. Each of the ports (116) is sized to allow a syringe filled with lubricant to inject lubricant into the reservoir (118) of the carriage base (104) via the ports (116).

Further, a structure that forms the ports (116) forms a visual inspection area, the visual inspection area allows for a visual determination of whether the reservoir (118), interior to the carriage base (104), is filled with the lubricant. For example, to determine if lubricant has been injected via the first port (116-1) to fill the reservoir (118) with the lubricant, a user may visually inspect a visual inspection area of the first port (116-1) and visually determine if they can see the lubricant. If the user can see the lubricant, the reservoir (118) has been filled with the lubricant. Similarly, to determine if lubricant has been injected via the second port (116-2) to fill the reservoir (118) with the lubricant, a user may visually inspect a visual inspection area of the second port (116-2) and visually determine if they can see the lubricant. If the user can see the lubricant, the reservoir (118) has been filled with the lubricant. The user can inspect either the visual inspection area of the first port (116-1) or the visual inspection area of the second port (116-2) to visually determine that the reservoir (118) is filled with the lubricant. The user inspects both the visual inspection area of the first port (116-1) and the visual inspection area of the second port (116-2) to visually determine that the reservoir (118) is filled with the lubricant. As a result, the visual inspection areas of each of the ports (116) may allow for a visual determination of whether the reservoir (118) is filled with lubricant.

As mentioned above, the lubricating system (114) includes the reservoir (118). The reservoir (118) may be a repository interior to the carriage base (104) that is used to retain lubricant. The reservoir (118) may be filled with lubricant at a time of manufacture of a printer via the ports (116) and through the ports (116) as desired thereafter.

The lubricating system (114) includes a number of channels (120). The lubricating system (114) includes a first channel (120-1), a second channel (120-2), a third channel (120-3), and a forth channel (120-4). Each of the channels (120) is connected to the reservoir (118). As a result, the number of channels (120) in the carriage base (104) may be used to extract, based on a pressure differential, lubricant from the reservoir (118) of the carriage base (104) and deliver lubricant to locations where the carriage bearings (124) of the carriage base (104) make contact with a carriage rod (106) of the printer (100) to reduce friction between the carriage bearings (124) and the carriage rod (106). More information about the channels (120) is described in other parts of this specification.

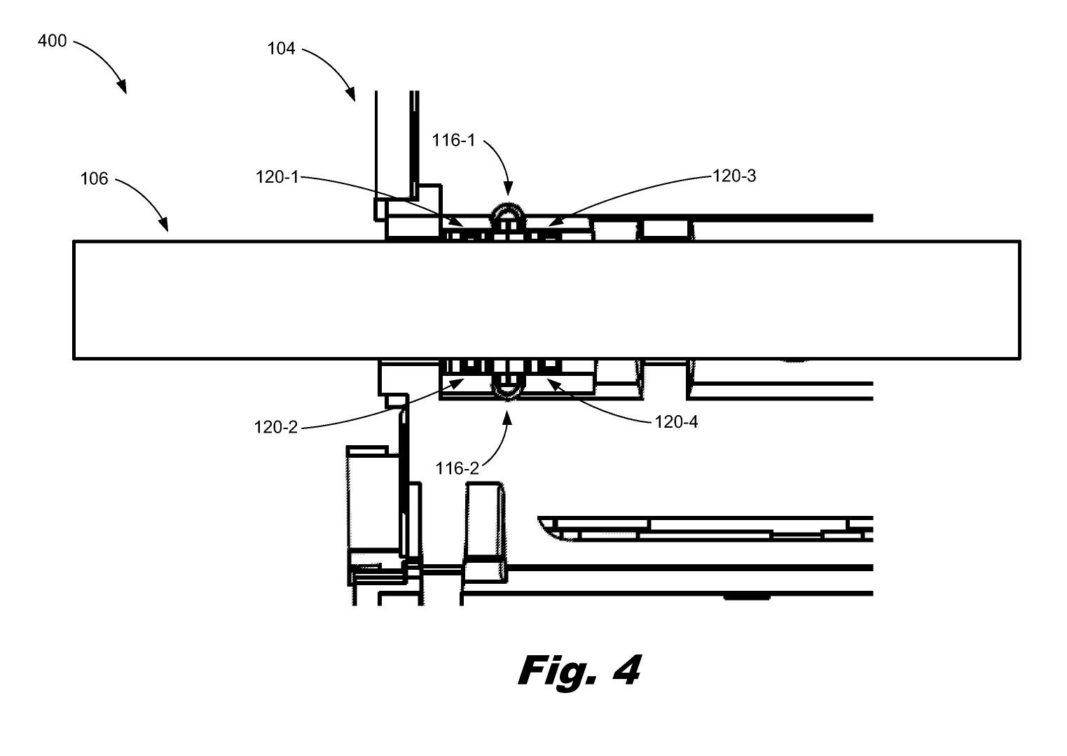

FIG. 4 is a diagram of a carriage base slidably mounted on a carriage rod, according to one example of principles described herein. As described below, a carriage base moves along a carriage rod. When the carriage base moves along the carriage rod, lubricant may be delivered to locations where carriage bearings (124) of the carriage base make contact with the carriage rod.

As illustrated, the carriage base (104) is slidably mounted on a carriage rod (106) via a number of carriage bearings (124) to allow the carriage base (104) to move back-and-forth along the carriage rod (106). Since the carriage rod (106) spans the length of the printer (100), the carriage base (104) may move from one side of the printer (100) to the other side of the printer (100) as driven by the motor (102).

When the carriage base (104) moves back-and-forth along the carriage rod (106), lubricant is extracted from the reservoir (118) via the number of channels (120). For example, as the carriage base (104) moves back-and-forth along the carriage rod (106), lubricant is extracted from the reservoir (118) via the first channel (120-1) and is delivered to locations where the carriage bearings (124) of the carriage base (104) make contact with the carriage rod (106). Similarly, lubricant is extracted from the reservoir (118) via the second channel (120-2), the third channel (120-3), and the forth channel (120-4) and is delivered to locations where the carriage bearings (124) of the carriage base (104) make contact with the carriage rod (106).

The lubricant is extracted from the reservoir (118) via the number of channels (120) via a pressure differential. The pressure differential may be created based on a difference in pressure between two points associated with a number of channels (120) molded into the carriage base (104) of the printer (100). The pressure differential may be determined between a point immediately inside one of the channels (120) and a point immediately outside the channels (120). The pressure differential may be created when the carriage base (104) is moving. For example, outside portions of the number of channels (120) may slightly protrude from the carriage base (104). The outside portions may be shaped similar to an airfoil such that when the carriage base (104) is moving, a higher pressure is created at a point immediately inside the channels (120) and a lower pressure is created at a point immediately outside of the channels (120). As a result, a pressure differential may be created. In some examples, the shape of the channels (120) may influence the pressure differential. For example, a channel that is a U serpentine shape may create a larger pressure differential than a channel that is a vertical slot. The U serpentine shape may create the larger pressure differential because a surface area associated with an opening of this channel may be greater than a surface area associated with an opening for the channel that is a vertical slot. The larger the pressure differential the larger the amount of lubricant that is extracted from a channel (120) and delivered to the carriage rod (106). As a result, the amount of the lubricant that is delivered to the carriage rod is controlled by the pressure differential which is determined, at least in part by a shape of the number of channels (120). As a result, lubricant may be extracted from the reservoir (118) and is delivered to the locations on the carriage rod (106). However, when the carriage base (104) is not moving, the pressure differential is not created. As a result, lubricant may not be extracted from the reservoir (118) and may not be delivered to the locations on the carriage rod (106).

The lubricant is extracted from the reservoir (118) via the number of channels (120) via drag created when lubricant contacts the carriage rod (106). For example, as lubricant is extracted from the channels (120), the lubricant contacts the carriage rod (106). Due to the properties of the lubricant, such as the cohesiveness of the lubricant, the lubricant is extracted from the channels (120) due to the lubricant in the channels (120) directly contacting the carriage rod (106). This contact pulls the lubricant from the channels (120) and onto the carriage rod (106) only when the carriage base (104) is moving. As a result, lubricant may be extracted from the reservoir (118) and may be delivered to the locations. However, when the carriage base (104) is not moving the drag is not created. As a result, lubricant may not be extracted from the reservoir (118) and may not be delivered to the locations.

While this example has been described with reference to the lubricating system including four channels, the lubricating system may include any number of channels. For example, the lubricating system may include two channels or eight channels.

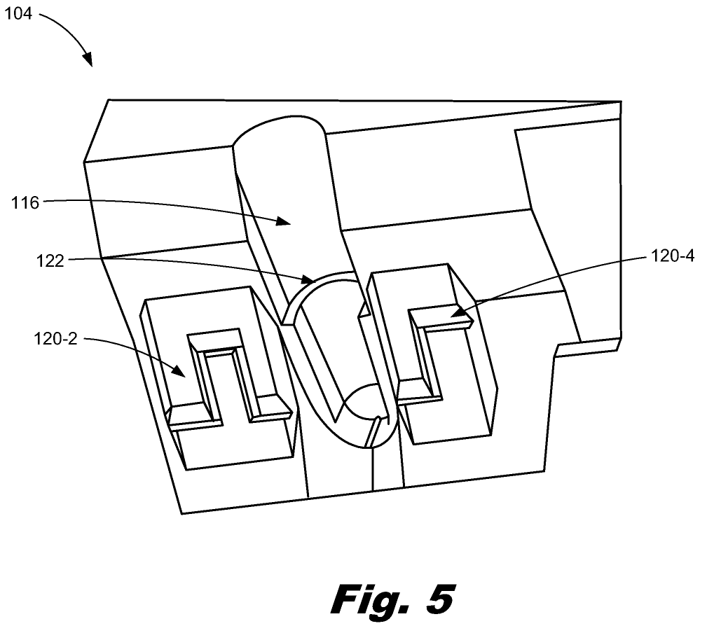

FIG. 5 is a diagram of a port and a number of channels molded into a carriage base, according to one example of principles described herein. As described below, the port may be used to inject lubricant into a reservoir. The channels may be used to extract the lubricant from the reservoir and deliver the lubricant to specific locations in the printer.

The carriage base (104) includes a port (116). As mentioned above, the port (116) is an input or connection point that provides access to a reservoir (118) in the carriage base (104) to allow lubricant to be injected into the reservoir (118). As noted above, the port (116) is sized to allow a syringe filled with lubricant to inject lubricant into the reservoir (118) of the carriage base (104). For example, if the syringe has an opening that is 5 millimeter (mm) to allow the lubricant to be ejected from, the port (116) may be sized slightly bigger to accommodate the opening of the syringe.

The port (116) includes a semi-seal (122). The semi-seal (122) is used to prevent lubricant from leaking out of the port (116) when lubricant is injected into the reservoir (118) via the syringe. In an example, when lubricant is injected into the reservoir (118) via the syringe, the syringe rests against the semi-seal (122). This creates a sealing effect that prevents lubricant from leaking out. In some examples, the semi-seal (122) may be made of a plastic. In other examples, the semi-seal (122) may be made of a rubber.

The carriage base (104) includes a number of channels (120). The channels (120) may be a passage in the carriage base (104) from the reservoir (118) to an opening located near a point of contact between the carriage bearings (124) and the carriage rod (106).

The channels (120) may be a particular shape. As illustrated, the shape of the channels (120) may be a U serpentine shape. In other examples, the shape of the channels (120) may be a series of vertical slots. The shape of the channels (120) may be a series of horizontal slots. The shape of the channels (120) may be a pattern such as a chevron pattern, a herringbone pattern, or other patterns. The width of the channels (120) may be between 0.15 mm to 0.30 mm wide. The width of the channels (120) may be 0.21 mm wide.

In an example, the shape of the channels (120) may determine a pressure differential that is created and may be determined by a point immediately inside one of the channels and a point immediately outside the channels. For example, a channel that is a U serpentine shape may create a larger pressure differential than a channel that is a vertical slot shape.

As noted above, the larger the pressure differential the larger the amount of lubricant that is extracted from the channels (120). In one example, the smaller the pressure differential the smaller the amount of lubricant that is extracted from the channels (120). As a result, the amount of lubricant that is delivered to the locations is may also be determined by a shape of the number of channels (120).

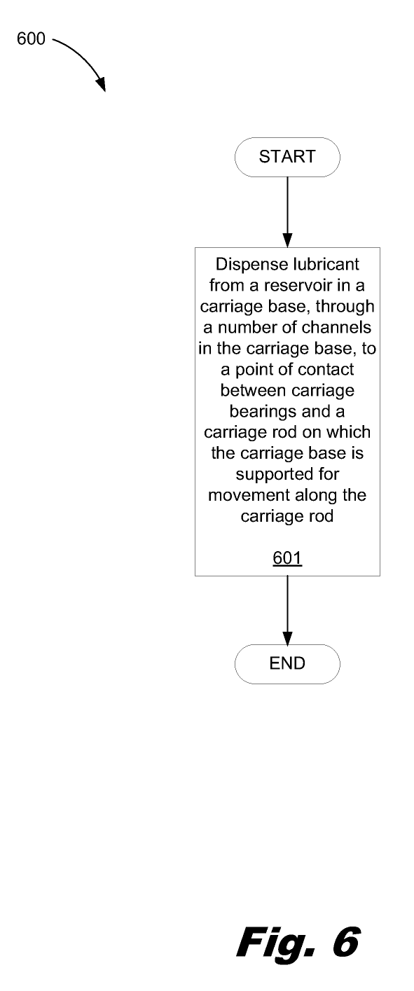

FIG. 6 is a flowchart a method for lubricating locations in a printer to reduce friction, according to one example of principles described herein. In this example, the method (600) includes dispensing (601) lubricant from a reservoir in a carriage base, through a number of channels in the carriage base, to a point of contact between carriage bearings and a carriage rod on which the carriage base is supported for movement along the carriage rod.

As mentioned above, the method (600) includes dispensing (601) lubricant from a reservoir in a carriage base, through a number of channels in the carriage base, to a point of contact between carriage bearings (124) and a carriage rod on which the carriage base is supported for movement along the carriage rod. Lubricant may be dispensed based on a pressure differential. Lubricant may be dispensed based on drag. In an example, the lubricant is delivered through the number of channels in response to a pressure differential between an interior and exterior of the number of channels. As a result, lubricant may be delivered to the carriage rod.

As noted above, during the printing process, the carriage rod (106) frequently becomes contaminated with debris. The debris may include print medium particles, aerosol, printing fluid, dust, other debris, and mixtures of these. The lubricant on the carriage rod (106) keeps this debris from sticking to the carriage rod (106). This eliminates the buildup of the debris on the carriage rod (106) and ultimately reduces friction. Since the friction is reduced, performance of the printer is increased because the motor does not have to work as hard due to the lower friction between the carriage bearings (124) and the carriage rod (106). This may result in higher customer satisfaction with the printer because performance, such as the pages per minute that the printer can print, may not decrease because the motor may not experience thermal slow down as often. In an example, because of the lower friction, the lifespan of the components of the printer may be extended because these components of the printer may not overheat.

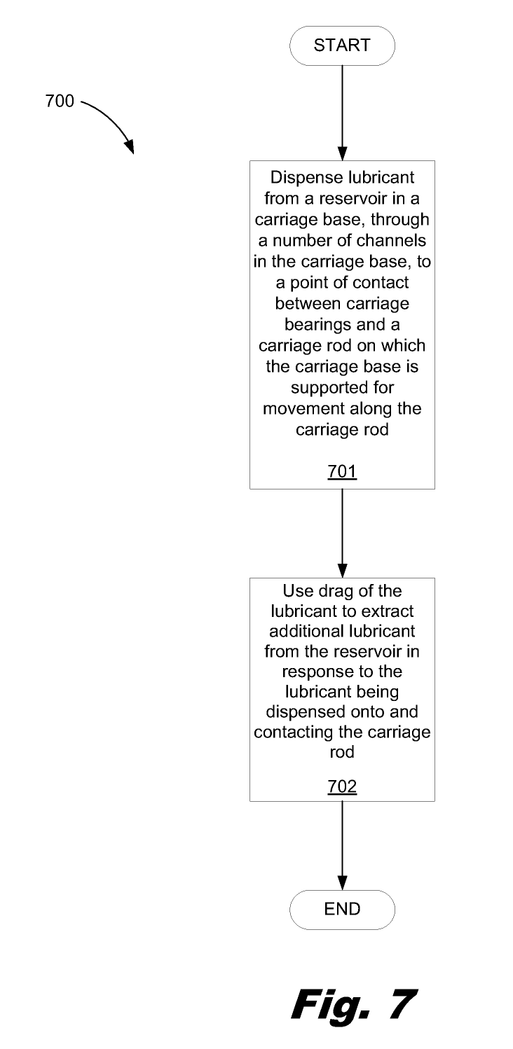

FIG. 7 is a flowchart a method for lubricating locations in a printer to reduce friction, according to one example of principles described herein. In this example, the method (700) includes dispensing (701) lubricant from a reservoir in a carriage base, through a number of channels in the carriage base, to a point of contact between carriage bearings and a carriage rod on which the carriage base is supported for movement along the carriage rod, and using (702) drag of the lubricant to extract additional lubricant from the reservoir in response to the lubricant being dispensed onto and contacting the carriage rod.

As mentioned above, the method (700) includes using (702) drag of the lubricant to extract additional lubricant from the reservoir in response to the lubricant being dispensed onto and contacting the carriage rod (106). When lubricant contacts the carriage rod (106), the viscosity of the lubricant draws the lubricant out of the number of channels (120) and onto the carriage rod (106). As a result, lubricant may be extracted via drag.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for lubricating, the system comprising:
a port to provide access to a reservoir in a carriage base to allow lubricant to be injected into the reservoir; and
a number of channels molded into the carriage base to extract the lubricant from the reservoir and deliver the lubricant to locations where carriage bearings of the carriage base are in contact with a carriage rod of a printer to reduce friction.

2. The system of claim 1, wherein the lubricant is delivered to the locations via a pressure differential created by the number of channels when a motor drives the carriage base back-and-forth along the carriage rod.

3. The system of claim 1, wherein a structure that forms the port forms a visual inspection area, the visual inspection area to allow for a visual determination of whether the reservoir is filled with the lubricant.

4. The system of claim 1, wherein the port is sized to allow a syringe filled with the lubricant to inject the lubricant into the reservoir of the carriage base.

5. The system of claim 4, wherein the port comprises a semi-seal to prevent the lubricant from leaking out of the port when the lubricant is injected into the reservoir via the syringe.

6. The system of claim 1, wherein a shape of the number of channels creates a pressure differential to extract the lubricant from the reservoir and deliver the lubricant to the locations when the carriage base moves back-and-forth along the carriage rod.

7. A system for lubricating, the system comprising:
a carriage base slidably mounted on a carriage rod of a printer via a number of carriage bearings to allow the carriage base to move along the carriage rod; and
a motor to move the carriage base along the carriage rod;
wherein a number of channels are molded into the carriage base to extract, based on a pressure differential, lubricant from a reservoir of the carriage base and deliver the lubricant to locations where the carriage bearings of the carriage base are in contact with the carriage rod.

8. The system of claim 7, wherein a shape of the number of channels creates the pressure differential to extract the lubricant from the reservoir and deliver the lubricant to the locations when the carriage base moves along the carriage rod.

9. The system of claim 7, wherein the lubricant is extracted from the reservoir via the number of channels via drag created when the lubricant contacts the carriage rod.

10. The system of claim 7, wherein an amount of the lubricant that is delivered to the locations is determined by a shape of the number of channels, the shape being a U serpentine shape.

11. The system of claim 7, further comprising a port to provide access to the reservoir in the carriage base to allow the lubricant to be injected into the reservoir.

12. The system of claim 11, wherein a structure that forms the port forms a visual inspection area, the visual inspection area to allow for a visual determination of whether the reservoir is filled with the lubricant.

13. A method for lubricating, the method comprising:
dispensing lubricant from a reservoir in a carriage base, through a number of channels in the carriage base, to a point of contact between carriage bearings and a carriage rod on which the carriage base is supported for movement along the carriage rod;
the lubricant being delivered through the number of channels in response to a pressure differential between an interior and exterior of the number of channels.

14. The method of claim 13, using drag of the lubricant to extract additional lubricant from the reservoir in response to the lubricant being dispensed onto and contacting the carriage rod.

15. The method of claim 14, wherein an amount of the lubricant that is delivered to the carriage rod is controlled by the pressure differential which is determined, at least in part by a shape of the number of channels.
